(19) United States
(12) Patent Application Publication
(10) Pub. No.: US 2003/0144898 A1
(43) Pub. Date: Jul. 31, 2003

(54) System, method and computer program product for effective content management in a pull environment

(76) Inventors: Eric Bibelnieks, Ogema, WI (US); David A. Selby, Hampshire (GB); Vincent Thomas, Severna Park, MD (US)

Correspondence Address: Mark D. Simpson, Esq., Synnestvedt & Lechner, 2600 Aramark Tower, 1101 Market Street, Philadelphia, PA, 19107-2950, US

(21) Appl. No.: 10/062,035

(22) Filed: Jan. 31, 2002

(51) Int. Cl. G06F 17/60

(52) U.S. Cl. 705/10

(57) ABSTRACT

A dynamic content management method, system, and computer program product by which interactive content is analyzed and scrutinized on a “real time” basis as users interact with the content presentation is disclosed. This is accomplished by, among other things, utilizing a rules engine or other known selection processor to facilitate dynamic decision making, whereby the selection processor “qualifies” the user for membership in a particular content-testing campaign; content (e.g., an offer or particular web design elements) to be presented to the user is selected and delivered; and the selection of the content, the failure to select the content, and the possible outcome of selecting the content is recorded in an operational database for that user so that it may be used to modify the content presented to that user in the future.

### BACKGROUND OF THE INVENTION

1. Field of the Invention

The present invention relates to push/pull marketing and, more particularly, management of content in an interactive environment.

2. Description of the Related Art

As technology advances, methods of advertising for products and services have also advanced. With the advances in and proliferation of the Internet, more and more advertising is being disseminated on the World Wide Web. Traditional advertising (the delivery of information directly to the user via direct mailings, email, and the like) is often referred to as “push” advertising because the advertising target is simply exposed to the content in an unsolicited manner (i.e., the content is “pushed” to them). The area of most growth with regard to Internet advertising is “pull” type advertising. In the context of the Internet, pull advertising involves website users “pulling” content (e.g., advertising or other content from the business, government agency sponsoring the website). A website is a typical example of a pull environment, where the potential consumer actively seeks and pulls the information by clicking on a web address, icon, or by other known identification method. In addition to use with web-enabled devices such as PCs, kiosks, and PDAs, pull advertising may also be utilized with call centers, “smart” vending machines, and other such systems that allow interaction between consumers and operators of the system.

In a push advertising campaign, the target audience is essentially forced to see or hear the advertising and thus the size of the advertising campaign is known when the campaign starts. Further, in a push campaign the advertiser controls the number of times the offer is made, for example, by sending catalogs, mailings, etc., or by ceasing to send them. By contrast, in a pull advertising campaign the size of the campaign is dependent upon how many of the target customers actually choose to view (or in the case of a call center, hear) the advertisement during the duration of the campaign, i.e., the advertiser cannot with precision know at the beginning of the campaign how large it will be. The number of viewers or callers will not be known, and how many will pull the content will not be known. Further, in a pull channel the same content may be repeatedly made available each time a visitor visits a web page or other advertisement distribution site, and the customer may ignore that offer each time. If the user does not respond to the pull channel content on a particular web page, for example, this may indicate the use of ineffective content; however, in prior art systems, nothing is done to proactively and quickly identify this ineffective content so that it can be removed or replaced with effective content.

It is common for website owners to track the number of “hits” on their site and perhaps even track the number of hits on a particular pull advertisement on their site; however, this statistical information is typically stored in a database and analyzed weeks or even months after a user has come to the site; oftentimes this data contains information that might indicate the existence of an ineffective promotion, yet this information is not utilized until the ineffective promotion has been in place for quite some time.

Web designers are also interested in analyzing web content generally, even if it is not advertising per se, to improve the ability of the website to capture the interest of a site user and keep them on the site (referred to as the “stickiness” of the website). Backgrounds, colors, graphics, clickable buttons, etc. can all be changed by the web designer to increase a site's stickiness; accordingly, web designers would like to be able to test alternative design features on a site to determine what users like and dislike and then automatically implement the design feature(s) that are found to be most desirable to users or particular segments of users. However, the prior art provides no such test mechanism that can be implemented and utilized on a real-time basis.

Accordingly, it would be desirable to have available a method and system for analyzing and managing the use of pull-type content, such as web design features and Internet advertising campaigns, on a real-time basis so that ineffective content can be quickly identified and modified or discontinued.

### SUMMARY OF THE INVENTION

The present invention is a dynamic content management method by which interactive content is analyzed and scrutinized on a “real time” basis as users interact with the content presentation. This is accomplished by, among other things, utilizing a rules engine or other known selection processor to facilitate dynamic decision making, whereby the selection processor “qualifies” the user for membership in a particular content-testing campaign; content (e.g., an offer or particular web design elements) to be presented to the user is selected and delivered; and the selection of the content, the failure to select the content, and the possible outcome of selecting the content is recorded in an operational database for that user so that it may be used to modify the content presented to that user in the future.

### BRIEF DESCRIPTION OF THE DRAWINGS

FIG. 1 is a flowchart illustrating an example of the overall process performed in setting up and implementing the present invention;

FIG. 2 is a flowchart illustrating an example of the operative process of the present invention;

FIGS. 3A and 3B illustrate alternative web page designs that can be used in accordance with the present invention to test alternative website designs;

FIG. 4 illustrates an exemplary data processing network 440 in which the present invention may be practiced; and

FIG. 5 is a block diagram of a processing device 510 in accordance with the present invention.

### DETAILED DESCRIPTION OF THE PREFERRED EMBODIMENTS

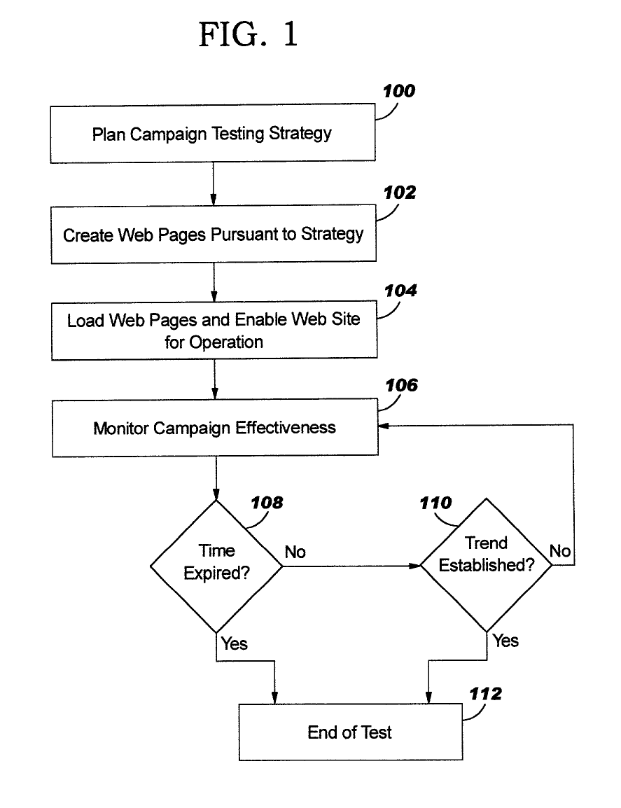

FIG. 1 is a flowchart illustrating an example of the overall process performed in setting up and implementing the present invention in connection with testing and implementing an advertising campaign on a website. It is understood that the same principles may be applied to test the effectiveness of content that elicits stickiness (e.g., graphics, photographs, text, backgrounds, etc.); and/or for content used at a call-center (typically presented to the caller in the form of either a recorded “tree system” or read from scripts by call-center operators); and/or for content used in connection with any known form of interactive medium.

For the purpose of this application, the following terms are used:

a “content developer” is a website developer, a call-center developer, a kiosk developer and the like;

a “content provider” is a website owner, a call-center owner, a kiosk owner and the like;

a “content planning team” comprises two or more content developers and/or content providers working together to set up and implement a campaign.

Referring to FIG. 1, at step 100, the content-planning team (or an individual content developer or content provider) first plans a strategy for testing the advertising campaign. The content planning team can choose one offer or several alternative sales offers for presentation to a particular target audience. By choosing alternatives, the content provider can try out different offers simultaneously and compare the results.

At step 102, the content developer creates web pages that will allow the strategy developed in step 100 to be implemented. For example, if three sales options involving “special offers” are decided upon, then the content developer sets up four alternative web pages—three for each alternative, and one without any special offer, to allow a “control group” to be established so that a determination can be made that the offers have, or don't have, an effect on sales.

At step 104, the content developer loads the web pages and enables the site for operation, using well known techniques. At step 106, the effectiveness of the campaign is monitored by keeping track of all sales made in connection with each of the four offers, and by tracking the “click-stream” of the visitors to the site using known click-stream tracking methods, and storing the sales and click-stream data for analysis. The effectiveness can be determined using known statistical analysis methods, e.g., using a rules engine that sets rules for effectiveness and then applies them to the data.

At step 108, a determination is made as to whether or not a predetermined period of time, established by the campaign-planning team, has expired. By setting a predetermined duration time for the campaign, the content provider can be assured that the campaign will be scrutinized promptly so that an ineffective web campaign will not remain available indefinitely and, hopefully, will be terminated promptly. As an alternative to, or in addition to, the time limitation, the test can be terminated after a predetermined number of users have been presented with the content choices. Thus, once a statistically significant number of users have visited the site, an assumption can be made at that point (without waiting for the expiration of the predetermined time period) that the statistical trends described by the data will apply to future users, and there is no need to continue sampling.

If, at step 108, a determination is made that the predetermined time period has expired (or, that the predetermined number of users have been presented with the content choices), then the process proceeds to step 112, where the test is ended and the results are stored and analyzed.

If, at step 108, it is determined that the predetermined time period has not expired (or that the predetermined number of users have not been presented with the choices), then the process proceeds to step 110, where a determination is made as to whether or not a trend has been established with respect to the content choices that indicates that one of the choices is significantly more successful than the others. For example, this determination could be established when one of the alternatives is achieving a success rate that exceeds that of the control group with a 95% confidence level (using well-known methods for determining a confidence level). It is understood that 95% is used by way of example only and any percentage can be used depending on the needs of the user. In a preferred embodiment, a minimum number of data points, as determined by the user, are required so that decisions are based on statistically significant data populations, thereby reducing the effect of statistical anomalies.

If, at step 110, it is determined that a statistically significant trend has not been established, then the process reverts to step 106 where the effectiveness of the content continues to be monitored. If at step 110 it is determined that a statistically significant trend has been established, then the process proceeds to step 112, where the test is terminated and the results analyzed and utilized to decide which of the choices to implement as the full-time content. The decisioning process used to make this choice can include any factors deemed relevant, such as click rate, purchase rate, value of goods purchased, and customer value. The outcome of the test and a report of the analysis are sent to the content planning team. The conclusion of the test may also cause the automatic instantiation of a new test if so desired by the content planning team or as a result of an optimization process.

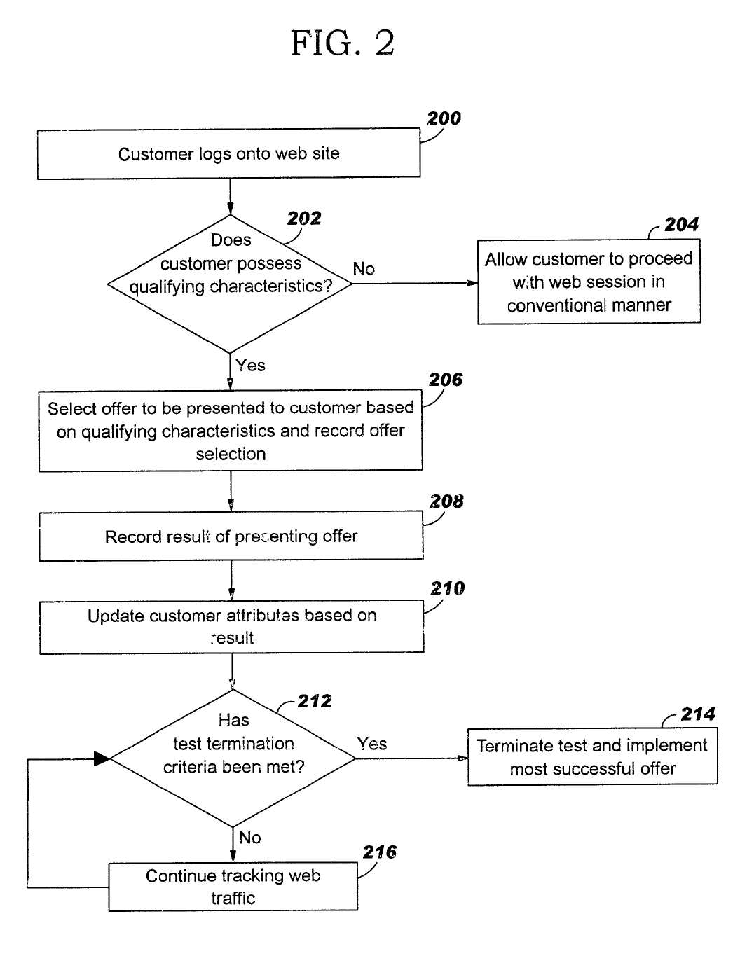

FIG. 2 is a flowchart illustrating an example of the operation of the present invention set up on a website. Referring to FIG. 2, at step 200, a user of the site logs onto the website developed and published by the content planning team. At step 202, a determination is made as to whether or not the user possesses the “qualifying characteristics” decided upon by the content planning team for the particular content. This can be accomplished in a well-known manner, using a rules engine or other known technology that can analyze data and determine if a particular condition or set of conditions applies to the data. For example, it may be desirable to limit the particular content testing to new users only, or repeat users only, or users of a particular gender, or users who reached the offer by taking a certain navigational route through the web site.

Thus, at step 202, data pertaining to the user (e.g., stored data (e.g., from prior visits to the site or from credit card information available to the content provider); data obtained during login; data found in a cookie associated with the user) is scrutinized and a determination is made as to the characteristics of the customer. In the context of accessing a website this might involve requiring a log-in by the user, thereby giving the website owner a “pointer” to a data file storing characteristics of the user. Cookies could also be used in a well known manner to ascertain characteristics of the user. For a call center, the pointer could be provided by the caller's Caller ID information.

If the user does not possess the qualifying characteristics of any of the content tests being performed (or they cannot be ascertained), then at step 204 the user is allowed to access the website in the conventional manner, i.e., they are brought to the opening page and allowed to roam freely without any special treatment or analysis of their visit (unless such analysis is desired). If possible, data can be gathered and stored during the visit so that data pertaining to the characteristics of this user will be available for any subsequent visits to the site.

If it is determined by the rules engine or other discrimination process that the user logging on possesses qualifying characteristics, then at step 206 the special offer(s) related to the qualifying characteristics are presented to the user, and the selections made by the user are recorded in a database using known techniques. Next, at step 208, the result of the offer selected by the user (e.g., did they request further information? Did they make a purchase? Did they disregard the offer?) is also recorded. This allows the content provider to see not only which offer was selected, but also if, as a result of selecting that offer, a sale was made.

At step 210, the attributes of the user are updated based on these selections. This allows the information obtained during the visit to be used the next time the user logs on to determine their qualifying characteristics with respect to other existing or future content. Then, at step 212, a determination is made as to whether or not the predetermined test termination criteria have been met (i.e., the expiration of the predetermined period of time; the determination that one of the content selections is producing statistically significant better results than the control group; etc.). If the criteria have been met, then at step 214 the test process is terminated and the most successful content selection is utilized for all future qualifying users. If the test termination criteria have not been met, the then at step 216 the process reverts back to tracking of the web traffic until the termination criteria have been met.

All of the above determinations regarding the data can be made using known data discrimination techniques such as the above-mentioned rules engines. The present invention enables the performance of real time testing of the effectiveness of ad campaigns, web content, graphical images used on website, etc., thereby providing instantaneous data regarding the effectiveness of the content and giving the content provider the ability to quickly make adjustments so that the most effective content is utilized. The following examples illustrate the operation of the present invention.

In a first example, a web campaign involves the testing of the effectiveness of three different incentives to be given to potential customers accessing a website. The three incentives are free shipping for every order; a 10% discount on every order; or a three-year extended warranty on the product being purchased. Since in this scenario the content provider is trying to determine or identify incentives that will draw in new customers, these incentives will only be offered to customers who have never purchased from the website before. Each time a first-time customer is identified in the customer discrimination step, it is assigned one of the three choices, or it is assigned no incentive at all. By selling to new customers without any incentive, a “control group” is established which allows the web seller to determine the effectiveness of the incentives.

Thus, in this example, the incentives (or lack thereof, in the case of the control group) are assigned on a sequential, rotating basis, that is, the first qualifier is offered free shipping, the second qualifier is offered a 10% discount, the third qualifier is offered a three-year extended warranty, the fourth qualifier is offered no incentive, the fifth qualifier is offered free shipping, etc. It is understood that there is no set order or sequence required; for example, the various alternatives could be tested serially instead of in parallel, so that every third visitor is assigned the same alternative, with other two thirds having no assignment (thus placing them in the control group), until a predetermined number of qualifying customers have been tested. Then the same procedure could be followed for the second alternative, and then the third, and then the results could be compared to determine which alternative performed best.

A finite period of time is set for the campaign, e.g., a two-month period during a typically high-volume shopping time and/or visits to the site by a predetermined number of qualifying visitors. Once the time period expires and/or the predetermined number of qualifying visitors is reached, the campaign is terminated and the results analyzed. In a preferred embodiment, if the time expires before the predetermined number of visitors is reached, a default choice can be used (e.g., continue to use no incentives until statistics identify an incentive that increases sales). However, since the effectiveness of the campaign options is constantly monitored, if one of the choices is significantly higher than the control group in terms of success, i.e., by a predetermined amount, then the campaign may be concluded before the expiration of the finite time period or predetermined number of visitors. Further, for a more accurate determination, the test could be run multiple times with the choice being made only if the “winner” wins repeatedly. Once a determination is made as to which option is most successful, that option becomes the continuing promotion, and the others are dropped. In this manner, when the continuing promotion is put into effect, it is already known that it stands a high probability of being a successful promotion.

A second example involves existing customers already having a high value to the content provider, i.e., they are loyal website customers who tend to purchase significant amounts. The thought process behind working with these customers is different than those in the first example; in the second example, the customers already are familiar with the website and the web seller is familiar with some of the proclivities of the customer. The idea behind offering them any incentive is to try to increase their value even more.

In this example, whenever the customer identification process identifies a customer logging onto the website as a high value, loyal customer, a choice of incentives are presented to them (with the exception of a control group who are offered no incentive). These incentives can be the same three as presented in the first example or they can be different, perhaps more “high end” incentives. To qualify for this campaign, the customer must meet certain criteria, e.g., they must have an “expected lifetime value” (a value assigned to previous customers based on any of a number of characteristics such as recency of purchase, frequency of purchase, monetary value of purchase, number of customers referred to the seller, etc.) that is greater than the cost of the incentive offer. The cost of the incentive offers may vary: for example, free shipping adds to the seller's costs by a fixed overhead amount; a 10% discount erodes the margin across all goods, rather than adding a fixed overhead amount; and the cost-impact of an extended warranty is dependent upon the expected level of warranty claims.

A third example involves a dial-in call center where customers call to order merchandise, receive information, etc. Through the use of Caller ID, a customer behavior profile can be accessed for each customer, thereby giving the content provider access to data from which the characteristics of the caller can be determined. In this example, the content planning team has decided to present the offer at a 1:12 ratio and test the content on callers from the East Coast of the United States. Thus, every twelfth caller calling from an East Coast area code is presented with the offer. When the twelfth qualifying caller calls into the call center, the scripts or “tree selections” used by the call center operator are adjusted so that the call center operator presents the twelfth caller with an offer of, for example, free shipping with a purchase. The acceptance, or failure to accept the offer is recorded and a database is updated to reflect the result of the presentation of the offer. If a certain ratio of callers-presented-with-the-offer-to-callers-accepting-the-offer is achieved, the rules engine can modify all scripts (or “tree selections”) so that future callers are each offered the free shipping.

The above invention can be implemented with kiosks, automatic teller machines, automatic gasoline stations where the pump has an LCD panel, “intelligent” vending machines, etc. In the case of ATMs, kiosks, and gasoline pumps, the characteristic information can be derived based upon the swiping of a magnetic card in the machine in a known manner and the identification of the owner of the card therefrom. In the case of the intelligent vending machine, which typically allows a cell phone user to dial the machine and place an order from the machine which is billed to the cell phone company, the characteristic information can be derived using Caller ID as discussed above. In addition, cookies may be used in a well-known manner to obtain a key to the characteristic information.

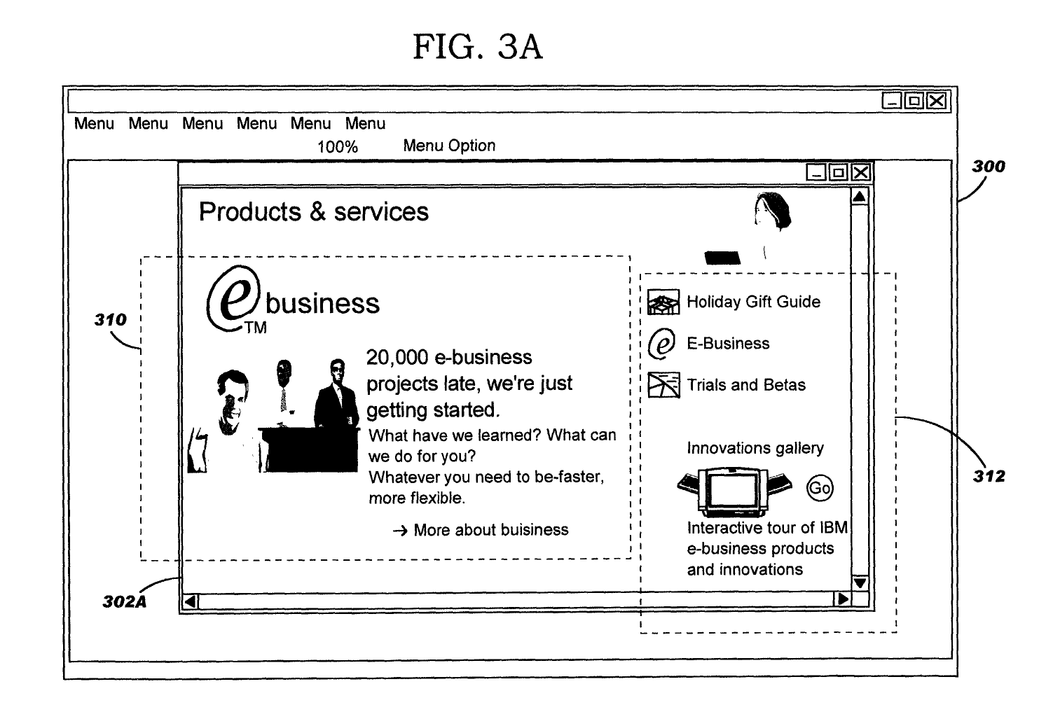

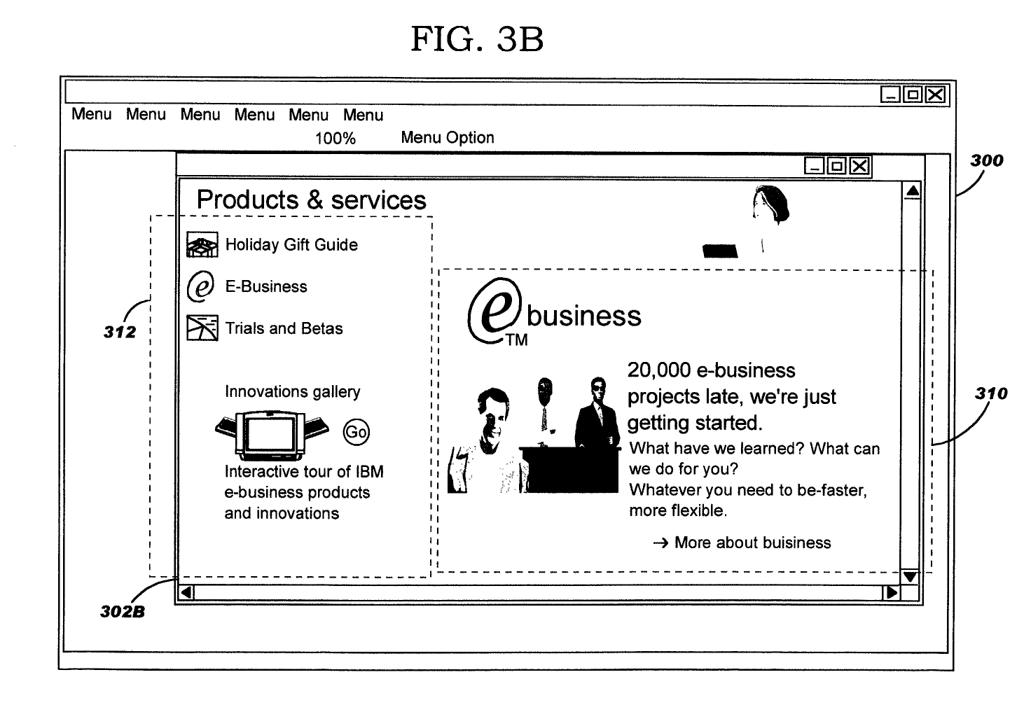

A fourth example involves web page design and the testing of a particular layout for stickiness. Reference is made to FIGS. 3A and 3B in connection with this example.

Referring to FIG. 3A, a GUI program window 300 displays a typical web page 302A. Within web page 302A are two “content areas” 310 and 312. FIG. 3B illustrates an alternative web page design for the website illustrated as 302B. As can be seen in FIG. 3B, content areas 310 and 312 have been reversed so that the image presented to a user by web page 302A of FIG. 3A is different than that displayed to a user of web page 302B in FIG. 3B. In this simplified example, web pages 302A and 302B are alternately shown to sequential users of the site so that one-half of the users are shown web page 302A and the other half are shown web page 302B. The user's click stream data is monitored and stored and then determinations can be made as to whether or not one layout directs users to particular links more often than another. Ideally, as in the previous three examples, the users are screened and only users having similar characteristics are shown the alternative choices; however, a test on the entire population of users can also be done, thereby negating the need to screen the characteristics of the users.

As with the previous examples, once a trend is established, the more successful of the two layouts is implemented for all future users. It is understood that the example illustrated in FIGS. 3A and 3B is simplified for ease of explanation; in actual implementation, much more significant differences between the two web pages would likely be in place, for example, different color backgrounds, different graphical images, different “buttons”, etc.

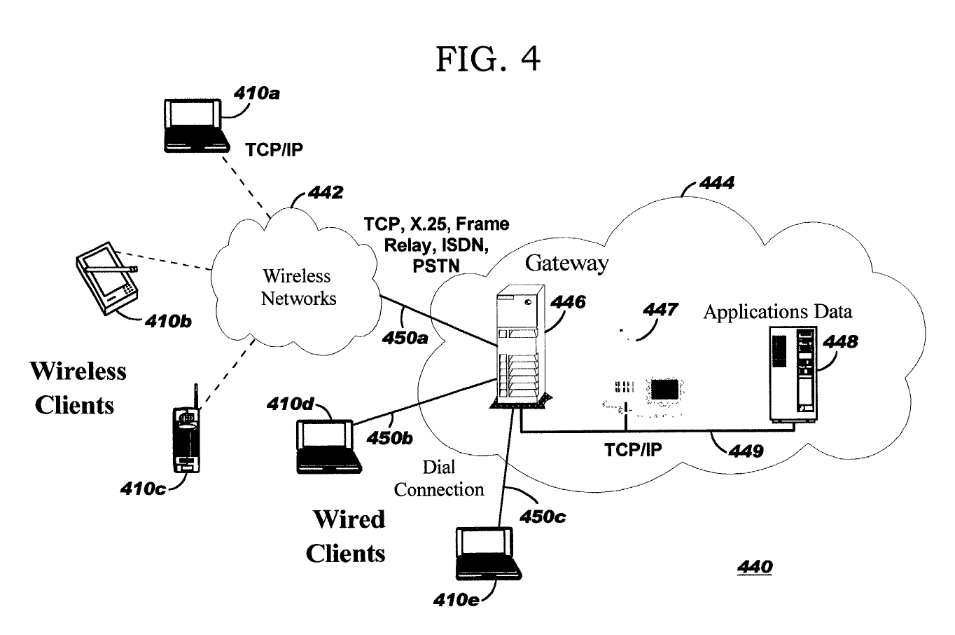

FIG. 4 illustrates an exemplary data processing network 440 in which the present invention may be practiced. The data processing network 440 may include a plurality of individual networks, such as wireless network 442 and network 444, each of which may include a plurality of individual workstations/devices, e.g. 410a, 410b, 410c. Additionally, as those skilled in the art will appreciate, one or more LANs may be included (not shown), where a LAN may comprise a plurality of intelligent workstations coupled to a host processor.

The networks 442 and 444 may also include mainframe computers or servers, such as a gateway computer 446 or application server 447 (which may access a data repository 448). A gateway computer 446 serves as a point of entry into each network 444. The gateway computer 446 may be preferably coupled to another network 442 by means of a communications link 450a. The gateway computer 446 may also be directly coupled to one or more workstations, e.g 410d, 410e using a communications link 450b, 450c. The gateway computer 446 may be implemented using any appropriate processor, such as IBM's Network Processor. For example, the gateway computer 446 may be implemented using an IBM pSeries (RS/6000) or xSeries (Netfinity) computer system, an Enterprise Systems Architecture/370 available from IBM, an Enterprise Systems Architecture/390 computer, etc. Depending on the application, a midrange computer, such as an Application System/400 (also known as an AS/400) may be employed. (“Enterprise Systems Architecture/370” is a trademark of IBM; “Enterprise Systems Architecture/390,” “Application System/400,” and “AS/400” are registered trademarks of IBM.) These are merely representative types of computers with which the present invention may be used.

The gateway computer 446 may also be coupled 449 to a storage device (such as data repository 448). Further, the gateway 446 may be directly or indirectly coupled to one or more workstations/devices 410d, 410e, and servers such as application server 447.

Those skilled in the art will appreciate that the gateway computer 446 may be located a great geographic distance from the network 442, and similarly, the workstations/devices may be located a substantial distance from the networks 442 and 444. For example, the network 442 may be located in California, while the gateway 446 may be located in Texas, and one or more of the workstations/devices 410 may be located in New York. The workstations/devices 410 may connect to the wireless network 442 using a networking protocol such as the Transmission Control Protocol/Internet Protocol (“TCP/IP”) over a number of alternative connection media, such as cellular phone, radio frequency networks, satellite networks, etc. The wireless network 442 preferably connects to the gateway 446 using a network connection 450a such as TCP or UDP (User Datagram Protocol) over IP, X.25, Frame Relay, ISDN (Integrated Services Digital Network), PSTN (Public Switched Telephone Network), etc. The workstations/devices 410 may alternatively connect directly to the gateway 446 using dial connections 450b or 450c. Further, the wireless network 442 and network 444 may connect to one or more other networks (not shown), in an analogous manner to that depicted in FIG. 4.

The present invention may be used on a client computer or server in a networking environment, or on a standalone workstation. (Note that references herein to client and server devices are for purposes of illustration and not of limitation: the present invention may also be used advantageously with other networking models.) When used in a networking environment, the client and server devices may be connected using a “wireline” connection or a “wireless” connection. Wireline connections are those that use physical media such as cables and telephone lines, whereas wireless connections use media such as satellite links, radio frequency waves, and infrared waves. Many connection techniques can be used with these various media, such as: using the computer's modem to establish a connection over a telephone line; using a LAN card such as Token Ring or Ethernet; using a cellular modem to establish a wireless connection; etc. The workstation or client computer may be any type of computer processor, including laptop, handheld or mobile computers; vehicle-mounted devices; desktop computers; mainframe computers; etc., having processing (and, optionally, communication) capabilities. The server, similarly, can be one of any number of different types of computer which have processing and communication capabilities. These techniques are well known in the art, and the hardware devices and software which enable their use are readily available.

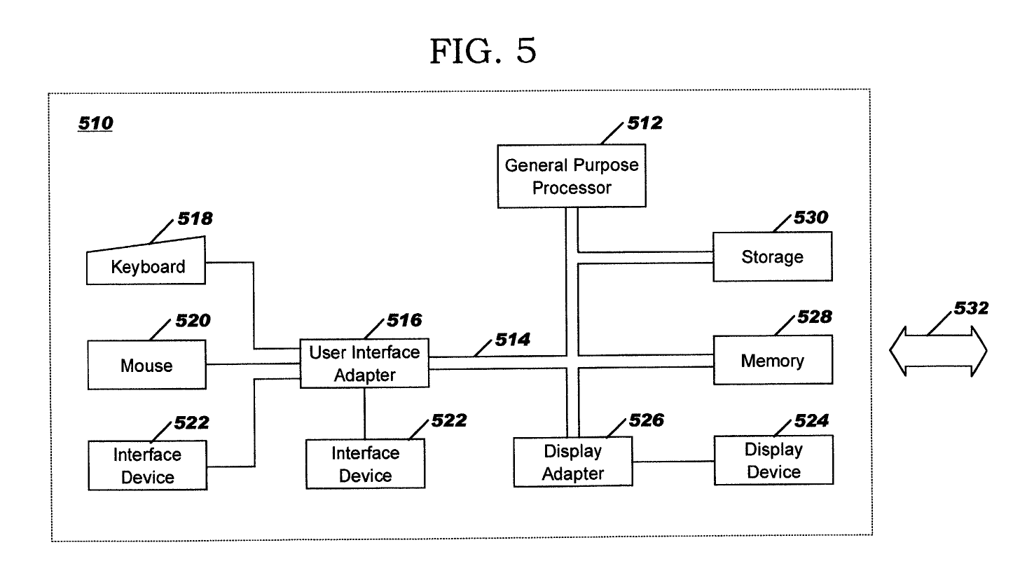

FIG. 5 is a block diagram of a processing device 510 in accordance with the present invention. The exemplary processing device 510 is representative of workstation 410a or server 446 of FIG. 4, as discussed above. This block diagram represents hardware for a local implementation or a remote implementation.

As is well known in the art, the workstation of FIG. 5 includes a representative processing device, e.g. a single user computer workstation 510, such as a personal computer, including related peripheral devices. The workstation 510 includes a general purpose microprocessor 512 and a bus 514 employed to connect and enable communication between the microprocessor 512 and the components of the workstation 510 in accordance with known techniques. The workstation 510 typically includes a user interface adapter 516, which connects the microprocessor 512 via the bus 514 to one or more interface devices, such as a keyboard 518, mouse 520, and/or other interface devices 522, which can be any user interface device, such as a touch sensitive screen, digitized entry pad, etc. The bus 514 also connects a display device 524, such as an LCD screen or monitor, to the microprocessor 512 via a display adapter 526. The bus 514 also connects the microprocessor 512 to memory 528 and long-term storage 530 (collectively, “memory”) which can include a hard drive, diskette drive, tape drive, etc.

The workstation 510 may communicate with other computers or networks of computers, for example, via a communications channel or modem 532. Alternatively, the workstation 510 may communicate using a wireless interface at 532, such as a CDPD (cellular digital packet data) card. The workstation 510 may be associated with such other computers in a LAN or a wide area network (WAN), or the workstation 510 can be a client in a client/server arrangement with another computer, etc. All of these configurations, as well as the appropriate communications hardware and software, are known in the art.

Having thus described a few particular embodiments of the invention, various alterations, modifications, and improvements will readily occur to those skilled in the art. Such alterations, modifications, and improvements are included in this disclosure and are intended to be part of this description though not expressly stated herein, and are intended to be within the spirit and scope of the invention. Accordingly, the foregoing description is by way of example only, and not limiting. The invention is limited only as defined in the following claims and equivalents thereto.

We claim:

1. A method for testing user reaction to multiple variants of interactive content in a pull environment, comprising the steps of:
identifying a population of content users;
defining rules that subdivide said population into plural subdivisions equal in number to the number of multiple variants of interactive content and assigning to each subdivision one of said multiple variants;
as each content user enters said pull environment, identifying, in real time, the subdivision to which they are assigned;
presenting interactive content to each content user entering said pull environment, in real time, based on the subdivision to which they are assigned;
monitoring, in real time, the reactions of said content users to the presented interactive content and storing data corresponding to said monitoring;
analyzing, in real time, said stored data and identifying statistical trends in said stored data; and
selecting, based on said statistical trends, at least one of said multiple variants of interactive content for continued use with all members of said population.

2. A method as set forth in claim 1, wherein said pull environment comprises a website and wherein said interactive content comprises website content, and wherein said population of users comprise users of said website.

3. A method as set forth in claim 2, wherein said rules subdivide said population into plural subdivisions based upon characteristics of said users.

4. A method as set forth in claim 3, wherein said characteristics comprise at least one characteristic related to demographics, prior activity on said website, or interests.

5. A method as set forth on claim 4, wherein said multiple variants comprise a plurality of web links, each web link directing a user activating said link to a different web page.

6. A method as set forth in claim 5, wherein said subdivision-assignment identifying step comprises the accessing of stored user data corresponding to a content-user entering said pull environment and matching user characteristics stored in said stored user data with characteristics identifying said subdivisions.

7. A method as set forth in claim 6, wherein said content users are required to follow a log-in procedure to access said website, and wherein stored user data comprises user login data.

8. A method as set forth in claim 6, wherein said stored data comprises prior purchase history of said content users.

9. A method as set forth in claim 6, wherein said monitoring of the reactions of said content users comprises tracking and storing the click-stream data corresponding to said content user.

10. A method as set forth in claim 9, wherein said statistical trends identify which of said multiple variants is most often selected by said population.

11. A method as set forth in claim 1 wherein said pull environment comprises a call center and wherein said interactive content comprises scripted materials presented to users of said call center, and wherein said population of users comprises users of said call center.

12. A method as set forth in claim 1 wherein said pull environment comprises an automatic teller machine (ATM) and wherein said interactive content comprises textual or audio content presented to users of said ATM, and wherein said population of users comprises users of said ATM.

13. A method as set forth in claim 1 wherein said pull environment comprises an intelligent vending machine and wherein said interactive content comprises textual or audio information displayed to users of said intelligent vending machine, and wherein said population of users comprises users of said intelligent vending machine.

14. A system for testing user reaction to multiple variants of interactive content in a pull environment, comprising:
means for identifying a population of content users;
means for defining rules that subdivide said population into plural subdivisions equal in number to the number of multiple variants of interactive content and assigning to each subdivision one of said multiple variants;
means for identifying, in real time, the subdivision to which each content user is assigned as they enter said pull environment;
means for presenting interactive content to each content user entering said pull environment, in real time, based on the subdivision to which they are assigned;
means for monitoring, in real time, the reactions of said content users to the presented interactive content and storing data corresponding to said monitoring;
means for analyzing said stored data and identifying statistical trends in said stored data; and
means for selecting, based on said statistical trends, at least one of said multiple variants of interactive content for continued use with all members of said population.

15. A system as set forth in claim 14, wherein said pull environment comprises a website and wherein said interactive content comprises website content, and wherein said population of users comprise users of said website.

16. A system as set forth in claim 15, wherein said rules subdivide said population into plural subdivisions based upon characteristics of said users.

17. A system as set forth in claim 16, wherein said characteristics comprise at least one characteristic related to demographics, prior activity on said website, or interests.

18. A system as set forth on claim 17, wherein said multiple variants comprise a plurality of web links, each web link directing a user activating said link to a different web page.

19. A system as set forth in claim 18, wherein said subdivision-assignment identifying means includes means for accessing stored user data corresponding to a content-user entering said pull environment and matching user characteristics stored in said stored user data with characteristics identifying said subdivisions.

20. A system as set forth in claim 19, wherein said content users are required to follow a log-in procedure to access said website, and wherein stored user data comprises user login data.

21. A system as set forth in claim 19, wherein said stored data comprises prior purchase history of said content users.

22. A system as set forth in claim 19, wherein said means for monitoring the reactions of said content users includes means for tracking and storing the click-stream data corresponding to said content user.

23. A system as set forth in claim 22, wherein said statistical trends identify which of said multiple variants is most often selected by said population.

24. A system as set forth in claim 14, wherein said pull environment comprises a call center and wherein said interactive content comprises scripted materials presented to users of said call center, and wherein said population of users comprises users of said call center.

25. A system as set forth in claim 14, wherein said pull environment comprises an automatic teller machine (ATM) and wherein said interactive content comprises textual or audio content presented to users of said ATM, and wherein said population of users comprises users of said ATM.

26. A system as set forth in claim 14, wherein said pull environment comprises an intelligent vending machine and wherein said interactive content comprises textual or audio information displayed to users of said intelligent vending machine, and wherein said population of users comprises users of said intelligent vending machine.

27. A computer program product for testing user reaction to multiple variants of interactive content in a pull environment, the computer program product comprising a computer-readable storage medium having computer-readable program code embodied in the medium, the computer-readable program code comprising:
computer-readable program code that identifies a population of content users;
computer-readable program code that defines rules that subdivide said population into plural subdivisions equal in number to the number of multiple variants of interactive content and assigns to each subdivision one of said multiple variants;
computer-readable program code that, as each content user enters said pull environment, identifies, in real time, the subdivision to which they are assigned;
computer-readable program code that presents interactive content to each content user entering said pull environment, in real time, based on the subdivision to which they are assigned;
computer-readable program code that monitors, in real time, the reactions of said content users to the presented interactive content and stores data corresponding to said monitoring;
computer-readable program code that analyzes said stored data and identifies statistical trends in said stored data; and
computer-readable program code that selects, based on said statistical trends, at least one of said multiple variants of interactive content for continued use with all members of said population.

28. A computer program product as set forth in claim 27, wherein said pull environment comprises a website and wherein said interactive content comprises website content, and wherein said population of users comprise users of said website.

29. A computer program product as set forth in claim 28, wherein said rules subdivide said population into plural subdivisions based upon characteristics of said users.

30. A computer program product as set forth in claim 29, wherein said characteristics comprise at least one characteristic related to demographics, prior activity on said website, or interests.

31. A computer program product as set forth on claim 30, wherein said multiple variants comprise a plurality of web links, each web link directing a user activating said link to a different web page.

32. A computer program product as set forth in claim 31, wherein said computer-readable program code that identifies subdivision assignments includes computer-readable program code that accesses stored user data corresponding to a content-user entering said pull environment and matches user characteristics stored in said stored user data with characteristics identifying said subdivisions.

33. A computer program product as set forth in claim 32, wherein said content users are required to follow a log-in procedure to access said website, and wherein stored user data comprises user login data.

34. A computer program product as set forth in claim 32, wherein said stored data comprises prior purchase history of said content users.

35. A computer program product as set forth in claim 32, wherein said monitoring of the reactions of said content users comprises tracking and storing the click-stream data corresponding to said content user.

36. A computer program product as set forth in claim 35, wherein said statistical trends identify which of said multiple variants is most often selected by said population.

37. A computer program product as set forth in claim 27 wherein said pull environment comprises a call center and wherein said interactive content comprises scripted materials presented to users of said call center, and wherein said population of users comprises users of said call center.

38. A computer program product as set forth in claim 27 wherein said pull environment comprises an automatic teller machine (ATM) and wherein said interactive content comprises textual or audio content presented to users of said ATM, and wherein said population of users comprises users of said ATM.

39. A computer program product as set forth in claim 27 wherein said pull environment comprises an intelligent vending machine and wherein said interactive content comprises textual or audio information displayed to users of said intelligent vending machine, and wherein said population of users comprises users of said intelligent vending machine.
